(19) United States
(12) Patent Application Publication
(10) Pub. No.: US 2014/0258054 A1
(43) Pub. Date: Sep. 11, 2014

(54) SYSTEMS AND METHODS FOR FINANCIAL ACCOUNTING

(71) Applicant: Stephen L. Seawall, Topeka, KS (US)

(72) Inventor: Stephen L. Seawall, Topeka, KS (US)

(21) Appl. No.: 13/792,110

(22) Filed: Mar. 10, 2013

(51) Int. Cl. G06Q 40/00

(52) U.S. Cl. CPC G06Q 40/10
USPC 705/30

(57) ABSTRACT

An accounting system is configured to record single entry transactions (e.g., cash receipts, cash disbursements, accounts payable, payroll payable, legal commitments) and to generate, in response to a selection by a user made after the transactions have been recorded, a selected one of a cash basis report and a budgetary basis report. Other systems and methods are provided.

### TECHNICAL FIELD

The technical field comprises data management. The technical field also comprises accounting data management, and accounting systems and methods.

### BACKGROUND

Financial accounting and reporting systems vary considerably depending on the type of the accounting entity and the entity's financial reporting needs.

Financial accounting entities can be grouped in different ways. Three common groups include 1) private financial accounting entities, 2) public financial accounting entities, and 3) individuals as financial accounting entities.

Private financial accounting entities are commonly referred to as the private sector entities. These are private business entities that take on different types of legal structures, such as corporations, partnerships, and sole proprietorships. Private business entities can be as simple as a single business owner operating a single-purpose type of business such as a beauty shop, or as complex as a corporate enterprise with many different types of operating business segments.

Public financial accounting entities are commonly referred to as the public sector entities. These are primarily state and local governments. Local governments can range from a limited-purpose governmental unit, to a more complex multiple-purpose governmental unit. For example, a rural water district might have the single purpose of providing water to rural patrons. A city, on the other hand, might provide utility services, public safety services, and transportation-related services to its patrons.

Individuals as accounting entities can take on different forms, such as a single person, a married couple, or a family of four.

Financial reporting needs can generally be grouped into two types—1) external reporting, and 2) internal reporting.

External reporting is usually intended to satisfy the reporting needs of persons external to the accounting entity, such as stockholders, investors, banks, and tax payers. External reporting is commonly based on authoritative guidelines or requirements imposed on the accounting entity, such as generally accepted accounting principles and federal and state laws and regulations. For example, a bank might require special financial statements or reports if the entity is seeking a loan from the bank. A local government might be required to prepare special financial statements or reports to demonstrate compliance with state budget laws.

Internal reporting is usually intended to provide financial statements and reports that management of the accounting entity is interested in on a day-to-day and month-to-month basis. Such reports might include monitoring of cash, sales, accounts receivable, inventory, and accounts payable on a daily or weekly basis. Typically, accounting entities will prepare monthly financial statements that provide some measure of the financial health of the entity.

Individuals generally have more limited financial accounting and reporting needs than private or public sector entities.

To help meet the varied financial reporting needs and requirements of accounting entities, financial statements are prepared using different bases of accounting. A basis of accounting defines the timing of recognition of transactions. That is, it determines when the effects of transactions or events should be recognized for financial reporting purposes. Two common bases of accounting include 1) cash basis of accounting, and 2) accrual basis of accounting. The cash basis of accounting is the simplest of the bases of accounting. Financial statements are based on when cash is received and when cash is disbursed. The accrual basis of accounting is commonly used by businesses to prepare an accrual basis statement of net income as well as an accrual basis statement of financial position (i.e., balance sheet).

Other bases of accounting are not as widely recognized as the cash basis and accrual basis. For example, the budgetary basis of accounting used by a local government might vary from state to state, depending on the state's budget laws.

The tax basis of accounting will depend on how the accounting entity reports taxable income.

Some bases of accounting are a modification of another basis of accounting. This is the case for some budgetary and tax bases of accounting. For example, a common type of budgetary basis of accounting is a modified cash basis of accounting, modified for the inclusion of encumbrances. Smaller businesses might use a modified cash basis of accounting for determining taxable income. Larger businesses might use a modified accrual basis of accounting for determining taxable income.

### SUMMARY

Some embodiments provide an accounting system configured to record single entry transactions (e.g., cash receipts, cash disbursements, accounts payable, payroll payable, legal commitments) and to generate, in response to a selection by a user made after the transactions have been recorded, a selected one of a cash basis report and a budgetary basis report.

Some embodiments provide an accounting method including recording transactions; generating a cash basis trial balance from the transactions; tagging cash transactions that may require an adjusting entry for accrual basis financial statements; tagging cash transactions that may require an adjusting entry for tax basis (cash) financial statements; tagging cash transactions that may require an adjusting entry for budgetary basis financial statements; tracking legal commitments including at least three of purchase orders, employee contracts, vendor contracts, long-term service contracts, long-term rental agreements, and lease agreements; in response to a request, generating a report identifying tagged transactions that may require an adjusting entry for accrual basis financial statements; in response to a request, generating a report identifying tagged transactions that may require an adjusting entry for tax basis (cash) financial statements; in response to a request, generating a report identifying tagged transactions that may require an adjusting entry for budgetary basis financial statements; importing a cash basis trial balance; receiving, from a user, adjusting entries for accrual basis financial statements; receiving, from a user, adjusting entries for tax basis financial statements; receiving, from a user, adjusting entries for budgetary basis financial statements; in response to a selection by a user after the transactions have been recorded, generating any selected one of a cash basis, budgetary basis, accrual tax basis, cash tax basis, and accrual basis financial statements for any of a year and an interim period of less than a year.

Some embodiments provide an accounting system comprising a central sub-system; a banking sub-system in communication with the central sub-system and configured to receive data from bank statements, the central sub-system being configured to receive bank statement data from the banking sub-system; a billing and accounts receivable sub-system, in communication with the central sub-system, and configured to receive data about incoming payments, and the central sub-system being configured to receive payment data from the billing and accounts receivable sub-system; and a payroll sub-system, in communication with the central sub-system, and configured to receive payroll cost data, the central sub-system being configured to receive payroll cost data from the payroll sub-system, the payroll sub-system being configured to generate payroll reporting data and to process payroll payable; the central sub-system being configured to track legal commitments including purchase orders, employee contracts, vendor contracts, long-term service contracts of more than one year, long-term rental agreements of more than one year, and lease agreements; and being configured to generate, in response to a selection by a user made after the payroll payable transactions have been processed, a selected one of a cash basis report, and a budgetary basis report.

### BRIEF DESCRIPTION OF THE VIEWS OF THE DRAWINGS

FIG. 1 is a hardware block diagram of a system in accordance with various embodiments.

FIG. 2 is a high level architecture block diagram of an accounting system included in the system of FIG. 1, in accordance with various embodiments,

FIG. 3 is a simplified functional block diagram showing major sub-systems included in the system of FIG. 2, in accordance with various embodiments.

FIG. 4 is a functional block diagram illustrating operation of one of the sub-systems of FIG. 3, in accordance with various embodiments.

FIG. 5 is a functional block diagram illustrating operation of another one of the sub-systems of FIG. 3 in accordance with various embodiments.

FIG. 6 is a functional block diagram illustrating data verification procedures of the system of FIG. 2, in accordance with various embodiments.

FIG. 7 is a functional block diagram illustrating interim financial reporting procedures of the system of FIG. 2, in accordance with various embodiments.

FIG. 8 is a chart illustrating a financial statement generated by the system of FIG. 2 using a cash basis of accounting, in accordance with various embodiments.

FIG. 9 is a chart illustrating a financial statement generated by the system of FIG. 2 using a budgetary basis of accounting, in accordance with various embodiments.

FIG. 10 is a functional block diagram illustrating operation of a banking sub-system of the system of FIG. 2 and showing cash balance reconciliations, in accordance with various embodiments.

FIG. 11 is a functional block diagram illustrating operations in a billing and accounts receivable sub-system of the system of FIG. 2, in accordance with various embodiments.

FIG. 12 is a functional block diagram illustrating operations in a payroll sub-system of the system of FIG. 2, in accordance with various embodiments.

FIG. 13 is a functional block diagram illustrating how accrual basis statements are generated with the system of FIG. 2, in accordance with various embodiments.

FIG. 14 is a functional block diagram illustrating tagging and adjustments for capital assets performed by the system of FIG. 2, in accordance with various embodiments.

FIG. 15 is a functional block diagram illustrating tagging and adjustments for liabilities performed by the system of FIG. 2, in accordance with various embodiments.

FIG. 16 is a functional block diagram illustrating generation of tax basis income statements by the system of FIG. 2, in accordance with various embodiments.

FIG. 17 is a functional block diagram illustrating generation of different types of financial statements for different types of entities by the system of FIG. 2, in accordance with various embodiments.

FIG. 18 is a functional block diagram illustrating chart of accounts operations in the system of FIG. 2, in accordance with various embodiments.

FIG. 19 is a functional block diagram similar to FIG. 3 but showing more detail, in accordance with various embodiments.

### DETAILED DESCRIPTION OF THE ILLUSTRATED EMBODIMENTS

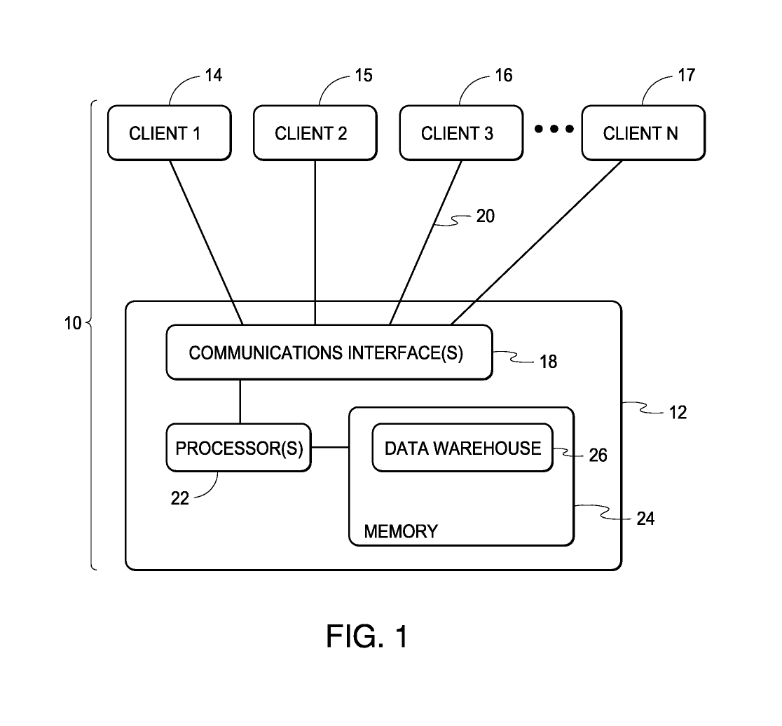

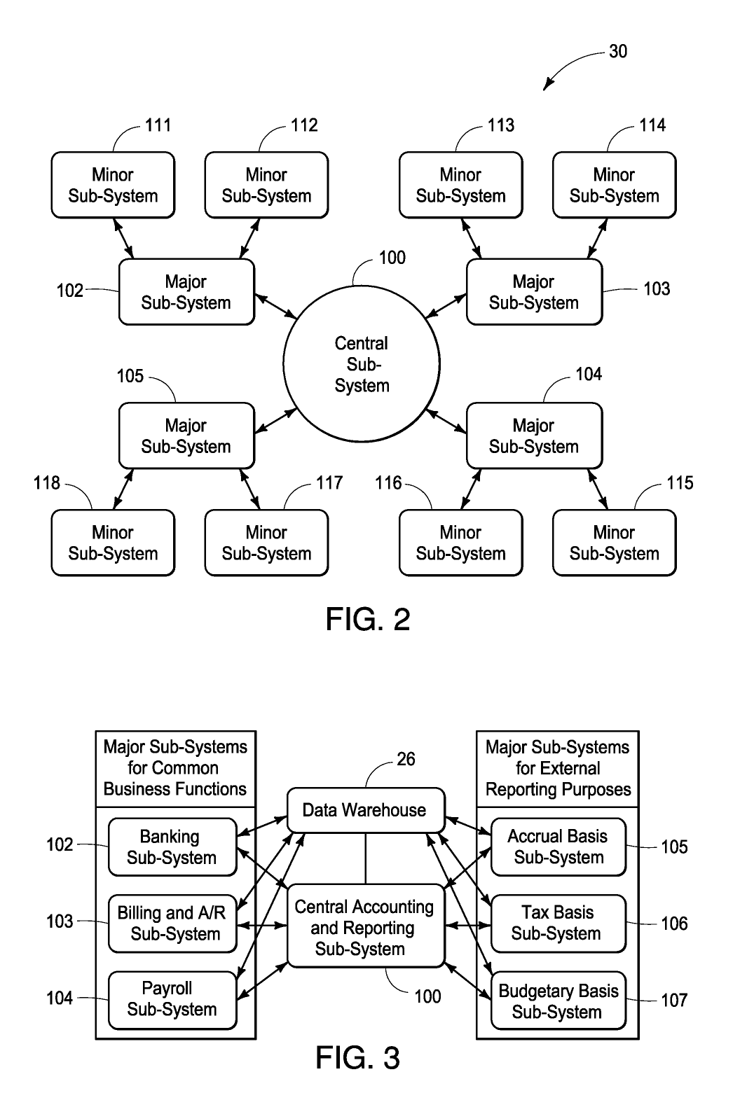

FIG. 1 shows a system 10 in accordance with various embodiments. The system 10 includes a server 12 and one or more client machines 14-17 (e.g., computers, smart phones, PDAs, computer terminals or other smart devices) in selective communication with the server 12. More particularly, the server 12 includes one or more communications interfaces 18 (such as modems or network devices) that receive connections from the clients 14-17 over communications links 20 (such as the Internet, a WAN, LAN, dial-up line, or other connection). The server 12 includes typical components of a server such as one or more processors 22 and a memory 24 in communication with the processor. Other components such as input devices (e.g., keyboards, mice) and output devices (e.g., monitors, touch screen panels) may or may not be included or may be selectively attached to the server 12 when desired. The memory 24 may include one or more of RAM, ROM, hard drives, optical drives, floptical drives, USB drives, or other forms of volatile or non-volatile memory. The memory 24 includes a data warehouse 26. The memory 24 and processor 22 define the accounting system 30 (see FIG. 2) of various embodiments. In some embodiments, a personal computer is used instead of the server 12. In other embodiments, various business units or various clients of an accounting firm access the server 12 from client machines 14-17.

Various embodiments provide a common approach to financial accounting and reporting that fits substantially all types of accounting entities, and supports substantially any basis of accounting. This approach is practical for all types of businesses, large and small. It is practical for state and local governments, large and small. It is practical for individuals as accounting entities. This one-approach-fits-all financial accounting and reporting system is largely enabled through the use of an accounting infrastructure, integration network, and chart of accounts, all of which are described below. In the discussion that follows, references such as “business segment” and “business owner” are used. Such references will take on different descriptions and different meanings depending on the type of accounting entity.

In various embodiments, the system 30 includes a financial accounting and reporting infrastructure that is open-ended. The infrastructure is designed around a network of accounting and reporting sub-systems (see FIG. 2). The sub-systems generally function independently or are capable of functioning at least mostly independently. However, all of the sub-systems are integrated with or in communications with one or more other sub-systems. Some of the sub-systems have primarily an accounting function, primarily a reporting function, or both.

In various embodiments, the heart of the sub-system network (see FIG. 2) is the central accounting and reporting sub-system 100. The central sub-system 100 is integrated with major sub-systems 102, 103, 104, 105, etc. The major sub-systems, in turn are also integrated with or in communications with one or more minor sub-systems 111, 112, 113, 114, 115, 116, 117, 118, etc.

The sub-system network includes the central accounting and reporting sub-system 100, major sub-systems 102-107, and a data warehouse 26 (see FIG. 3) that are in communication with the central accounting and reporting sub-system 100. The major sub-systems include sub-systems designed to perform functions that are common to nearly all businesses. In the illustrated embodiment, these sub-systems comprise banking sub-system 102, billing and accounts receivable sub-system 103, and payroll sub-system 104. The major sub-systems also include sub-systems designed primarily for external reporting, and are based on external reporting requirements (e.g., GAAP). In the illustrated embodiment, these sub-systems comprise accrual basis sub-system 105, tax basis sub-system 106, and budgetary basis sub-system 107.

The central accounting and reporting sub-system 100 serves multiple purposes including central data storage, central data processing, central data verification, interim (management) financial reporting, and precursor to external reporting.

In the illustrated embodiments, most, but not all transactional data stored in the central accounting sub-system originates there. Some financial data originates in another accounting sub-system, but is then converted for use in the central accounting sub-system 100. Such is the case with the payroll sub-system 104 and the billing and accounts receivable sub-system 103.

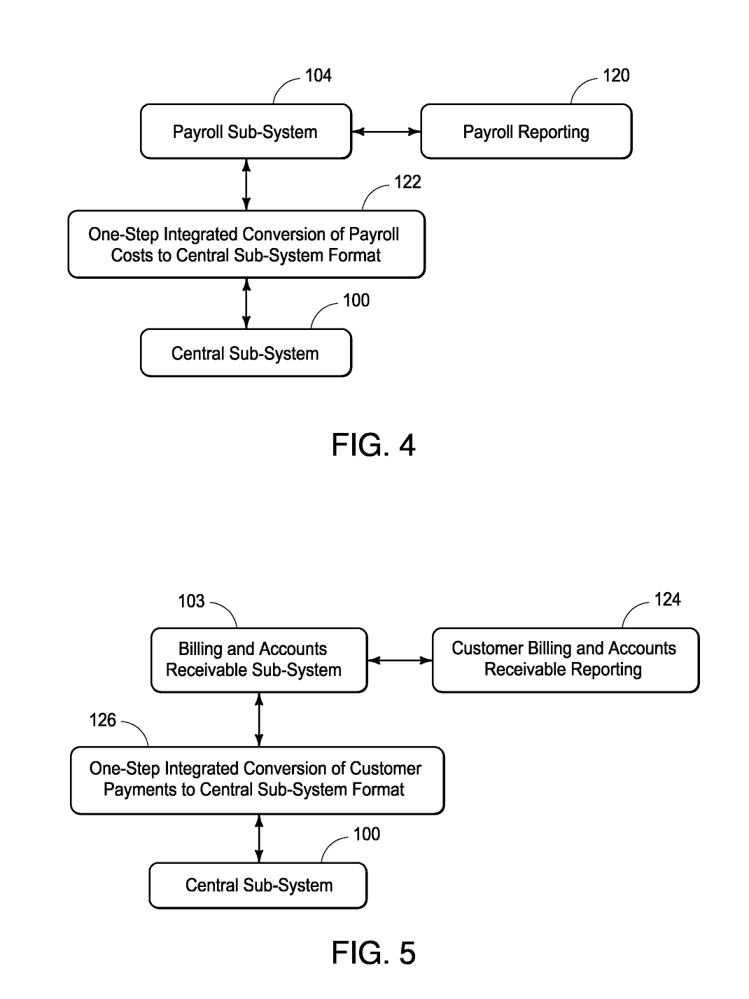

For example, as shown in FIG. 4, payroll transactions originate in the payroll sub-system 104; however, the payroll transactional data is stored in a format designed for payroll reporting 120, in various embodiments, such as by employee tax identification number, gross pay, fringe benefits, paycheck deductions, and net pay. Payroll costs are then broken down based on the amount that goes to the employee (net pay), and the remaining amounts that go to the federal government (federal income tax withholding, social security, and Medicare), the state government, and other recipients. The payroll data is therefore converted 122 to a different format for storage and use in the central accounting system 100. That is, the payroll costs are broken down into cash disbursements by business segment, department, and object (type of disbursement).

Similarly, the customer payments recorded in the billing and accounts receivable sub-system 103 (see FIG. 5) are stored in a format for customer billing and accounts receivable reporting 124 but are converted 126 to another format for storage and use in the central accounting system. That is, customer payments are broken down into cash receipts by business segment, department, and object (type of receipt) for storage and use in the central sub-system 100.

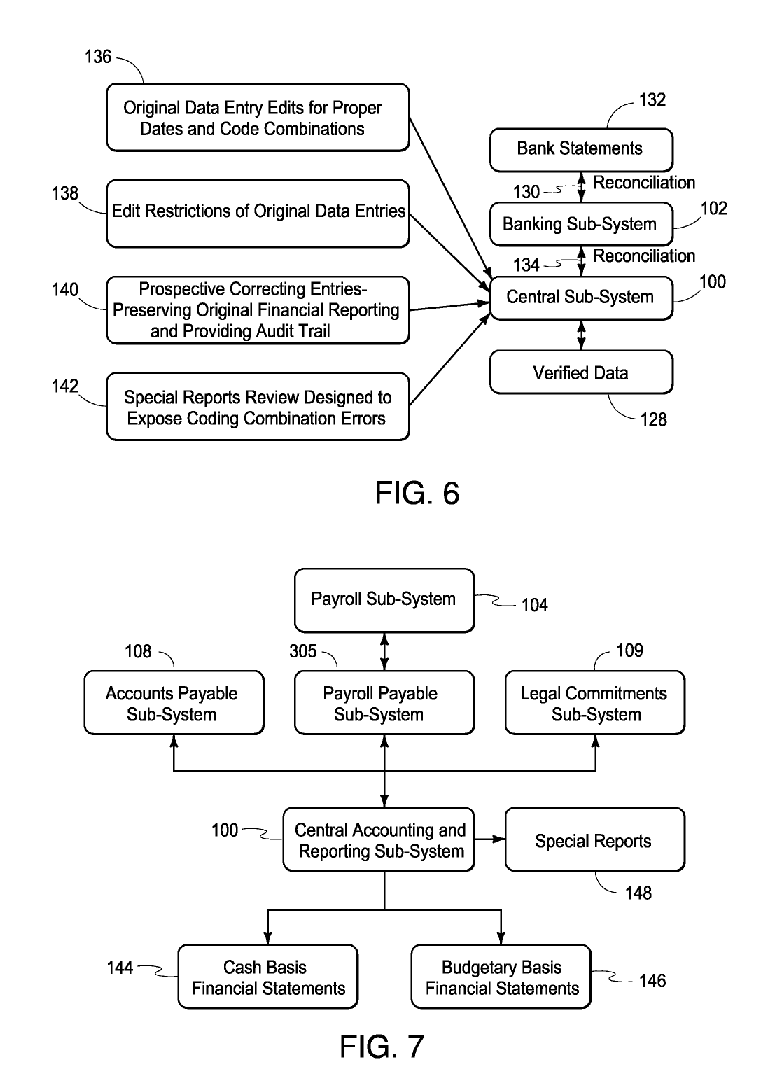

In some embodiments, data verification techniques are employed to provide a high level of assurance regarding accuracy of the data 128 (see FIG. 6) being stored in the central accounting sub-system 100. These can include, for example, reconciling 130 bank statements 132 with the banking sub-system 102, reconciling 134 data between the banking sub-system 102 and the central sub-system 100, data entry verification edits 136 to prevent transaction dating and coding errors, edit restrictions 138 on original data entries, prospective correcting entries (preserving original financial reporting and providing audit trail) 140, and year-end (or month-end) procedures 142 that center around special reports that allow the user to easily spot certain types of coding errors. “Prospective correcting entries” are entries made in the central sub-system 100 to correct an entry made previously in the same fiscal year, but in a prior interim (monthly) reporting period. Most such entries are made prospectively to maintain the integrity of the original entries.

As shown in FIG. 7 the central sub-system 100, in various embodiments, can generate financial statements using both the cash basis 144 of accounting and the budgetary basis 146 of accounting, including both summary and detailed statements.

FIG. 7 also shows that the payroll sub-system 104 feeds payroll payable data into the payroll payable sub-system 305. Other sub-systems, including an accounts payable sub-system 108, and legal commitments sub-system 109 feed data into the central sub-system 100. In various embodiments, the central sub-system 100 interacts with the accounts payable, payroll payable, and legal commitments sub-systems 108, 305, and 109 to provide needed data for the budgetary basis financial statements 146. The budgetary basis financial statements created in the central sub-system use a default budgetary basis of accounting which is a modified cash basis of accounting, modified for the inclusion of encumbrances (legal commitments). Encumbrances include outstanding purchase orders and legal commitments related to unperformed contracts for goods or services.

Cash basis financial statements 144 monitor cash continuously. Typically, for any particular reporting period, such as a month, the financial statement will show the beginning and ending cash balance. The statement will also show cash receipts and cash disbursements. The report format provided by the central accounting and reporting sub-system 100 follows this formula: Beginning Cash+Cash Receipts−Cash Disbursements=Ending Cash.

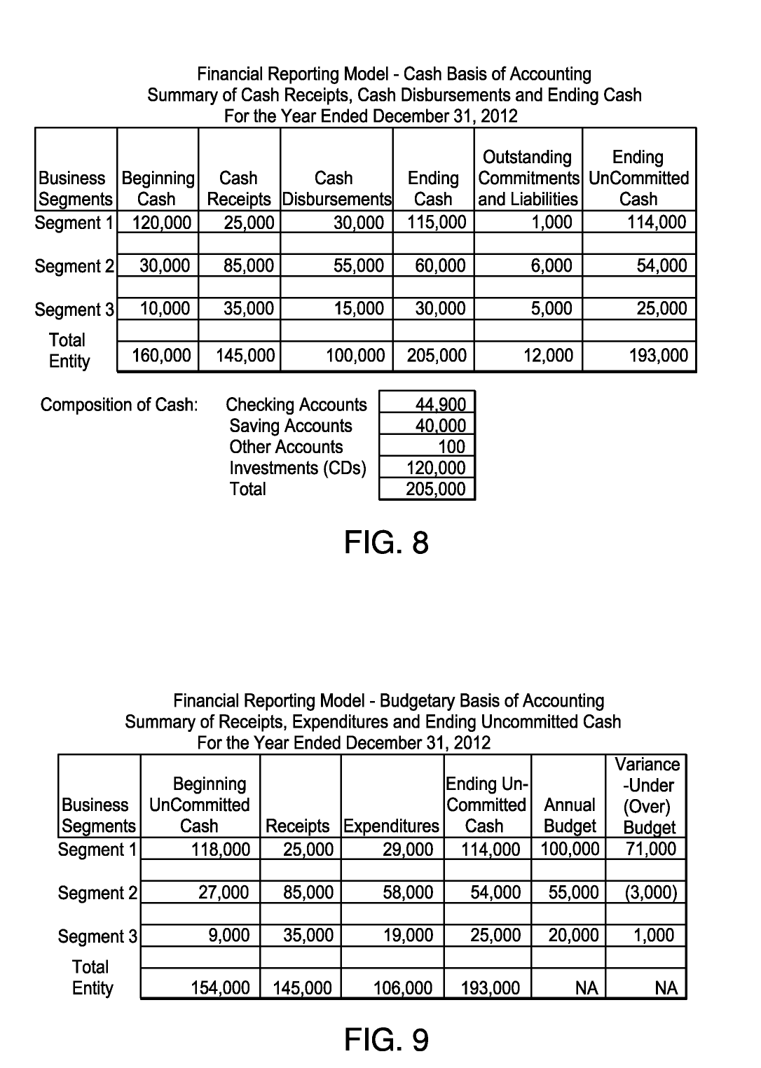

FIG. 8 provides an illustration of a cash basis financial statement for an annual period summarized by business segment. Individual business segment statements can be generated showing detail for cash receipts and cash disbursements. An advantage to the financial statement in FIG. 8 is that it demonstrates the tie between the total cash being reported in the central sub-system 100 (i.e., the books) and the total cash being reported in the banking sub-system 102 (i.e., total composition of cash).

Budgetary basis financial statements 146 (see FIG. 7) monitor uncommitted cash continuously. Typically, for any particular reporting period, such as a month, the financial statement will show the beginning and ending uncommitted cash balance. The statement will also show receipts and expenditures. The report format provided by the central accounting and reporting sub-system 100 follows this formula: Beginning Uncommitted Cash+Receipts−Expenditures=Ending Uncommitted Cash. For purposes of budgetary basis financial statement reporting, receipts include legal commitments, such as purchase orders, that were brought forward from a prior year, but cancelled in a subsequent year.

FIG. 9 provides an illustration of a budgetary basis financial statement for an annual period summarized by business segment. Individual business segment statements can be generated showing detail for receipts and expenditures.

An advantage to the financial statement shown in FIG. 9 is that it demonstrates the tie between the uncommitted cash being reported in the cash basis financial statements and the uncommitted cash being reporting in the budgetary basis financial statements.

The tie between the cash basis financial statements (see FIG. 8) and the budgetary basis financial statements (see FIG. 9) (i.e., uncommitted cash) can be extended back to the banking sub-system 102 (see FIG. 6) total cash. That is, the integration trail starts with total cash reported in the banking sub-system 102 (total composition of cash), which ties to total cash reported in the central sub-system 100 (i.e., the books), which in turn is reconciled to uncommitted cash in the cash basis financial statements (see FIG. 8), which ties to the uncommitted cash in the budgetary basis financial statements (see FIG. 9).

Expenditures under the budgetary basis of accounting include encumbrances (i.e., legal commitments) as well as liabilities. In various embodiments, the legal commitments sub-system 109 (see FIG. 7) tracks legal commitments from their inception (i.e., the date of the legal commitment to spend) to their liquidation (i.e., when the related goods or services are received and the commitment becomes a liability). Technically speaking, an expenditure (i.e., a charge to the budget) is recorded at the time a legal commitment is made. However, for practical reasons, there are exceptions to that rule for interim (monthly) financial reporting purposes. For example, routine outlays for salaries and wages are usually not reported until actual payment is made, at which time a cash disbursement is recorded and reported. Another exception is for small-dollar items that are expected to be paid within the current or following interim (monthly) reporting period. These exceptions generally do not apply for year-end reporting. In various embodiments, the central sub-system 100 (see FIG. 7) generates special reports that provide “drill-down” detail supporting individual items on the cash basis financial statements (see FIG. 8) and the budgetary basis financial statements (see FIG. 9). Such reports can be created at the original transaction level. This capability has the advantage of providing an audit trail for each financial statement item back to detailed source transactions.

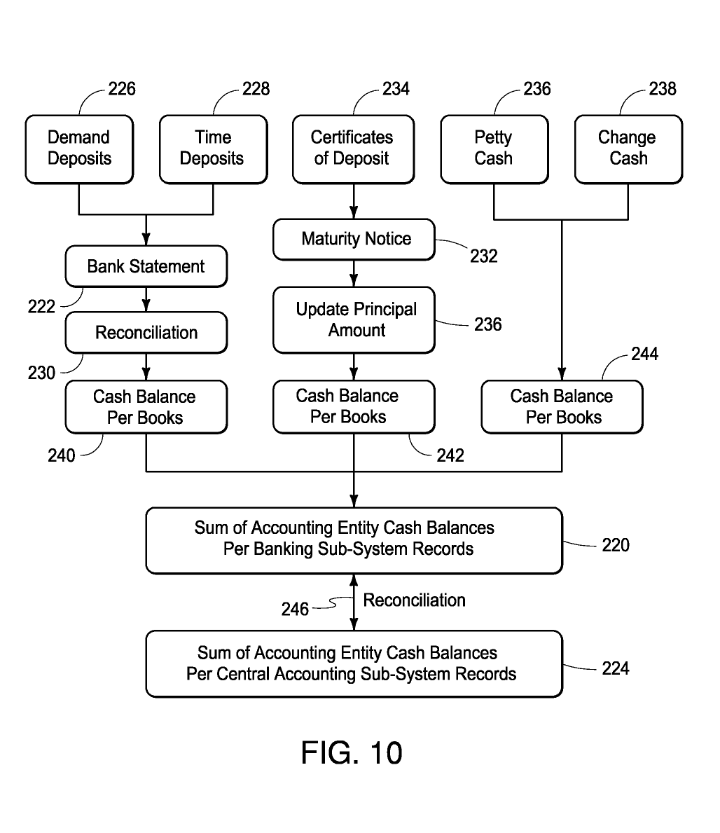

In various embodiments, the banking sub-system 102 (see FIG. 6) is designed to generate a detailed report 220 (see FIG. 10) of total cash that ties to the penny to external banking records, primarily month-end bank statements 222 (see FIG. 10) but also cash balances 242 for certificates of deposit 234 and cash balances 244 for petty cash 236 and change cash 238. This total 220, in turn, is used to verify (in reconciliation 246) the accuracy of the total cash 224 being reported in the central accounting sub-system 100, in some embodiments. That is, the total cash reported in the banking sub-system 102 must tie to the penny to the total cash in the central accounting sub-system 100, in some embodiments. FIG. 10 also illustrates that demand deposits 226 and time deposits 228 shown on bank statements 222 are used by the banking sub-system 102. In response to maturity notices 232 for certificates of deposit 234, amounts such as principal amounts 236 (and interest, depending on the maturity date) are updated in the system. The bank statements 222 are reconciled 230 with cash balance 240 per the books of the entity.

After performing month-end closing procedures, the total ending cash balance reported in the central sub-system 100 has been directly tied to not one, but two other, different sets of accounting records—the banking sub-system 102 and documents received from the bank, such as bank statements 222 and notices 232. Having three different sets of integrated accounting records, one of them being externally created, provides a high degree of accuracy to all of the cash transactions recorded in the central accounting sub-system 100.

In various embodiments, the banking sub-system 102 acts as a bridge between the bank depositories and the central sub-system 100. A role of this bridge is cash verification. This bridge also adds functionality to the business owner regarding the use of bank depositories. For example, the business owner has the option to use a single bank account for all cash receipt deposits and cash disbursements. Or, the business owner can use multiple bank accounts based on needs and preferences. The business owner might provide a separate bank account for certain business segments and a single bank account for all others. The business owner also has the flexibility of pooling idle (un-needed) cash balances for investment purposes. For example, certain business segments might have excessive cash balances that the owner wishes to invest centrally (i.e., at the accounting entity level).

Decisions about bank accounts and investing idle cash have minimal impact on the normal operations of the central accounting sub-system 100.

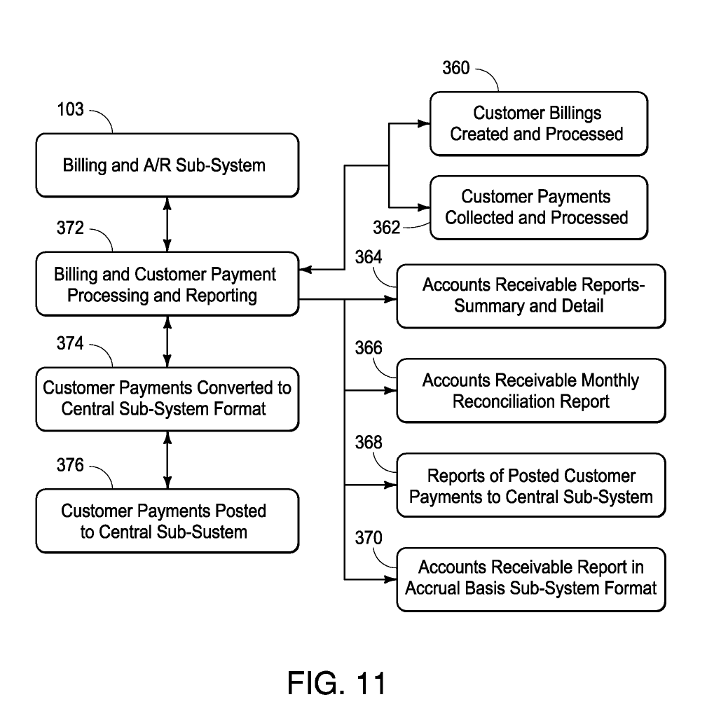

As shown in FIG. 11, the accounting for customer billings created and processed 360, and the accounting for customer payments collected and processed 362 is performed in the billing and accounts receivable sub-system 103. A function of this sub-system is to maintain accurate and up-to-date customer unpaid balances (accounts receivable). An accounts receivable report 364 can be generated in summary and in detail, for a single customer, for a business segment, or for the accounting entity. In various embodiments, billing and accounts receivable sub-system 103 can generate a monthly accounts receivable reconciliation report 366. This report reconciles the prior month-end accounts receivable to the current month-end accounts receivable. The report starts with the prior month-end amount, adds total billings for the month, subtracts total customer payments for the month to arrive at a “computed” current month-end accounts receivable amount. The total billings and total customer payments are obtained from billing and customer payment processing and reporting information 372 generated by the billing and accounts receivable sub-system 103. The “computed” month-end amount should tie to the current accounts receivable month-end report 364 generated in billing and accounts receivable sub-system 103. Customer payments are converted to the central sub-system 100 format in 374. Customer payments are posted to the central sub-system 100 in 376. Customer payments are summarized by business segment, department, and object (type of receipt) each day for posting to the central sub-system 100. The posting process automatically creates cash receipt journal entries in the central sub-system.

In various embodiments, billing and accounts receivable sub-system 103 can generate a monthly report of customer payments posted 368 to central sub-system 100. This report is summarized by business segment and can be used to tie the customer payments to cash receipts reported in central sub-system 100.

In various embodiments, an accounts receivable report 370 summarized by business segment is generated for use by the accrual basis reporting sub-system 105 (see FIG. 3). The report normally is created on a monthly basis.

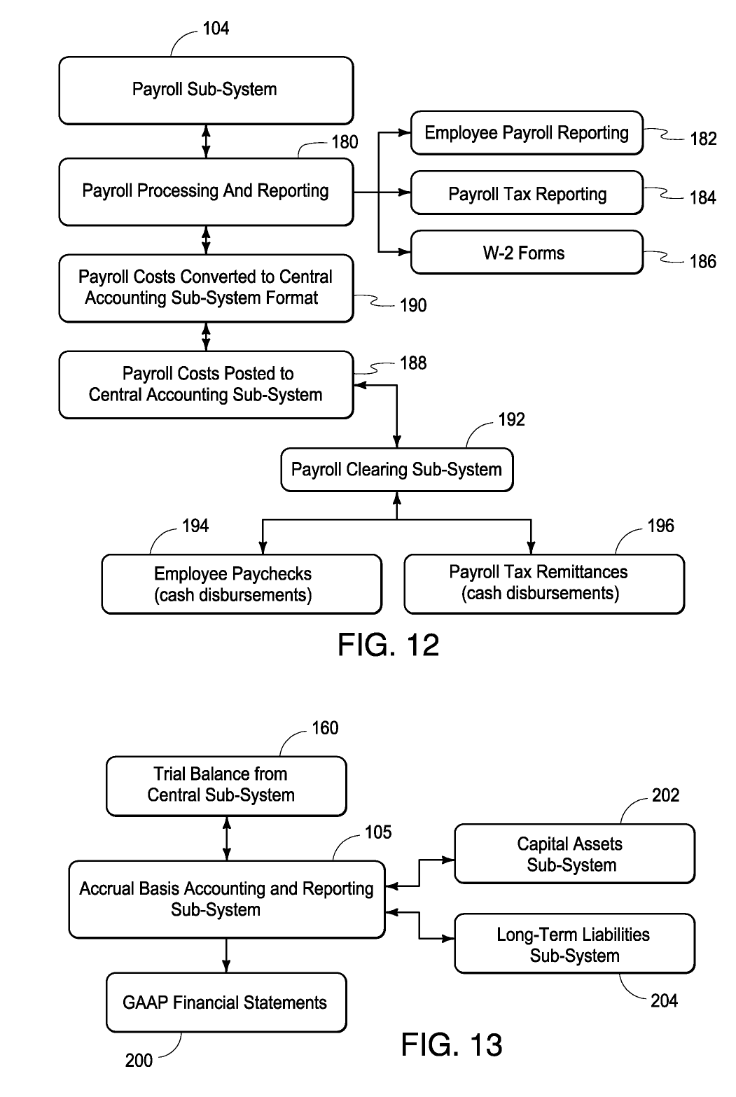

In various embodiments, the payroll sub-system 104 of FIG. 12 is integrated with the central sub-system 100 and also performs other accounting and reporting functions.

In various embodiments, a purpose of the integrated relationship between central sub-system 100 and payroll sub-system 104 is to convert the employee payroll costs recorded in the payroll sub-system 104 to a format compatible with the central sub-system 100 and export the data to the central sub-system 100. Also, the amount reported in the central sub-system 100 must be reconciled to the amount reported in the payroll sub-system 104, in various embodiments.

The payroll sub-system 104 has various financial accounting and reporting functions. One is payroll processing and reporting 180 (see FIG. 12) to maintain payroll-related records for employee payroll reporting 182 such as gross-to-net calculation, for payroll tax reporting 184 such as tracking deductions and fringe benefits for remittance purposes, and for year-end reporting 186 (e.g., W-2s). Another function is to convert payroll cost records 190 by business segment, department, and type of expenditure for posting 188 to the central sub-system 100.

In various embodiments, the posting process 188 automatically creates a set of charges that are recorded as cash disbursements in appropriate business segments in the central sub-system 100. Also, an inter-segment transfer of cash is made from the segment that is charged a specific payroll cost, to a payroll clearing sub-system 192.

Also, in various embodiments, the posting process 188 transfers the equivalent amount of cash to the payroll clearing sub-system 192 where related cash disbursements are processed and issued 194 in the form of paper checks or electronic fund transfers (ACH payments) for employee paychecks and vendor payroll (tax) remittances.

Various embodiments facilitate the conversion of payroll costs and posting to central sub-system 100. The conversion process is based in part on a conversion table set up in advance that provides information for each employee on how that employee's payroll costs should be charged in central sub-system 100 (i.e., how much is to be charged to each business segment, department, and object (type of disbursement). The procedure records and reports payroll costs in two different accounting and reporting formats—the payroll reporting format and the accounting entity financial statement reporting format (e.g., as used by sub-systems 100, and 105-107 in FIG. 3).

The major sub-systems for external reporting purposes include the accrual basis accounting and reporting sub-system 105, the tax basis accounting and reporting sub-system 106, and the budgetary basis accounting and reporting sub-system 107 shown in FIG. 3. External reporting is usually intended to satisfy the reporting needs of persons external to the accounting entity, such as stockholders, investors, banks, and tax payers. External reporting is commonly based on authoritative guidelines or requirements imposed on the accounting entity. For example, accrual basis financial reporting is based on generally accepted accounting principles. Tax basis financial reporting is based on federal regulations for federal taxable income. Budgetary basis financial reporting is based on state laws and regulations for local governments.

A purpose of the integrated relationship between the central accounting sub-system 100 and each of the external reporting sub-systems 105-107 is to provide the starting point for each external reporting sub-system's financial statement creation process. This starting point is in the form of a cash basis trial balance.

The reason for starting with a cash basis trial balance is that most of the transactional data reported in these three major sub-systems emanate from cash transactions. And that includes accrual basis financial statements. That means that most of the work required to prepare statements and reports in these major sub-systems has already been accomplished in the central accounting sub-system 100.

Also, various embodiments provide techniques to expedite the financial statement preparation process in accordance with those requirements, such as transaction tagging, described below in more detail.

The starting point for an accrual basis income statement 200 (see FIG. 13) is the cash basis trial balance 160 created using the central accounting and reporting sub-system 100. The starting point for a balance sheet is the ending balances carried forward from the previous reporting period.

Additional entries are fed into the accrual basis sub-system 105 from minor sub-systems 202 and 204. These minor sub-systems 202 and 204 store data related to entries for balance sheet items such as capital assets and long-term debt, respectively.

The trial balance 160 created for the accrual basis sub-system 105 consists of detailed cash receipts stored in the central sub-system 100 converted to higher level general ledger revenue accounts in the accrual basis sub-system 105 and detailed cash disbursements stored in the central sub-system 100 converted to higher level general ledger expense accounts in the accrual basis sub-system 105. However, using the accrual basis of accounting, not all cash receipts are reported as revenues, and not all cash disbursements are reported as expenses.

For example, using the cash basis of accounting, debt proceeds would be reported as cash receipts. Using the accrual basis of accounting, however, debt proceeds would not be reported as revenues in the statement of net income, but rather as a liability in the statement of financial position (i.e., balance sheet).

Similarly, using the cash basis of accounting, the purchase of a major asset, such as a vehicle, would be reported as a cash disbursement (assuming it was purchased with cash). Using the accrual basis of accounting, however, the vehicle would not be reported as an expense in the statement of net income, but rather as an asset in the statement of financial position (i.e., balance sheet).

These are examples of an inexact conversion of cash receipts and cash disbursements (cash basis reporting) to revenues and expenses (accrual basis reporting) respectively. Thus, adjusting entries are used in the accrual basis sub-system 105 to make appropriate adjustments. Adjusting entries are also used in the accrual basis sub-system 105 for other, non-cash related transactions. The accrual basis sub-system 105 provides a user interface to record all adjusting entries.

Adjusting entries might be needed for accounts receivable, interest receivable, pre-paid expenses, inventory changes, depreciation expense, accounts payable, payroll payable, interest payable, asset recognition, or debt liability recognition.

Various embodiments employ a tagging technique to identify cash transactions in the trial balance that need to be adjusted in some way. This feature is designed to facilitate the preparation of the accrual basis financial statements.

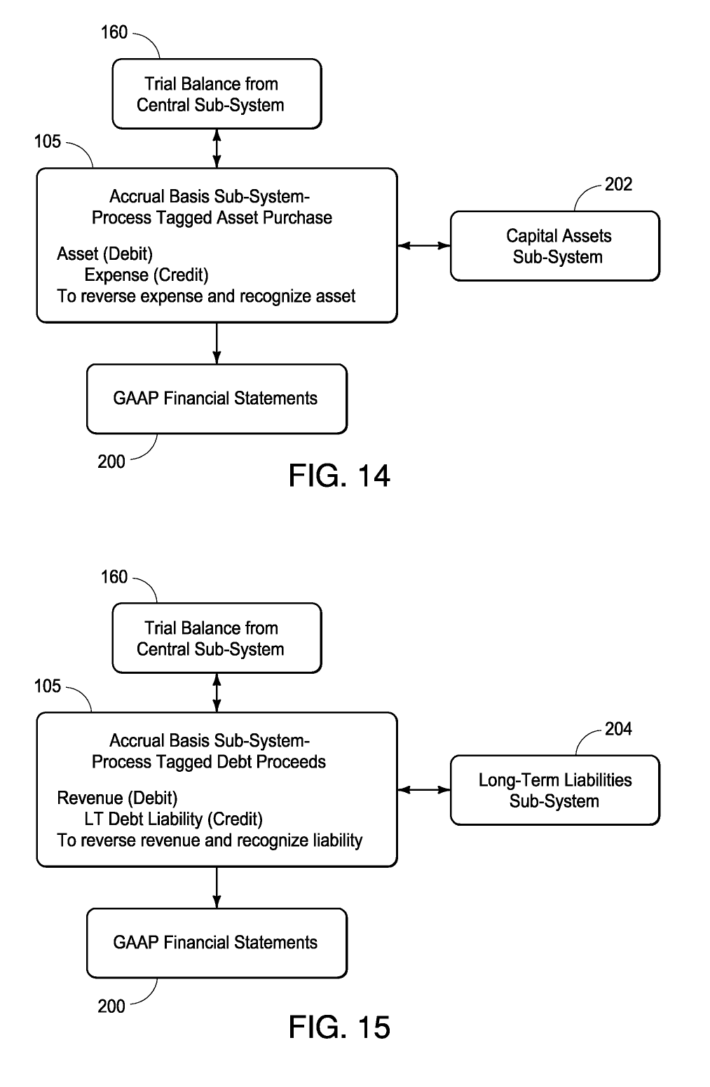

FIG. 14 shows the accrual basis sub-system 105 processing a tagged asset purchase from the trial balance 160 and using the capital assets sub-system 202. The asset is debited and the expense is credited to reverse the expense and recognize the asset.

FIG. 15 shows the accrual basis sub-system 105 processing tagged debt proceeds from the trial balance 160 and using the long-term liabilities sub-system 204. Revenue is debited and a long-term debt liability is credited to reverse revenue and recognize the liability.

In various embodiments, the accrual basis sub-system 105 does not actually process the tagged transaction automatically. Instead, it employs a user interface that alerts the user (e.g., an accountant) to the transaction. If the user decides an adjusting entry is needed, the user interface assists the user accountant with the most likely alternatives. It is the user who actually creates the adjusting entries in the system in various embodiments. After all adjusting entries have been created in the accrual basis sub-system 105, GAAP financial statements 200 can be created.

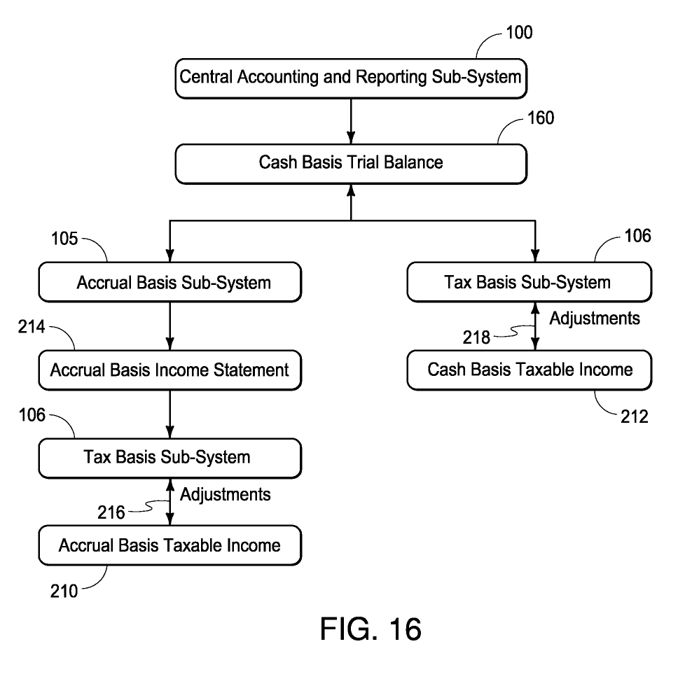

The starting point for a tax basis income statement 210 or 212 (see FIG. 16) is either a cash basis trial balance 160 created using the central accounting and reporting sub-system 100, or an accrual basis income statement 214 created using the accrual basis accounting and reporting sub-system 105. In either case adjusting entries 216 and 218 may be required, such as for depreciation expense.

There are numerous variations of the budgetary basis of accounting in use. However, various embodiments use a modified cash basis of accounting, modified for the inclusion of encumbrances (legal commitments). This modified cash basis of accounting is included by default as a part of the central accounting and reporting sub-system 100. The budgetary basis sub-system 107 (see FIG. 3) is provided in case it is needed.

Various embodiments provide a business owner flexibility to create any of a variety of types of financial statements or reports, at any time (for any reporting period), based on needs and resources. For example, the business owner can create accrual basis financial statements, cash basis statements or reports, budgetary basis statements or reports, tax basis statements, every month, at year-end, or anything in-between.

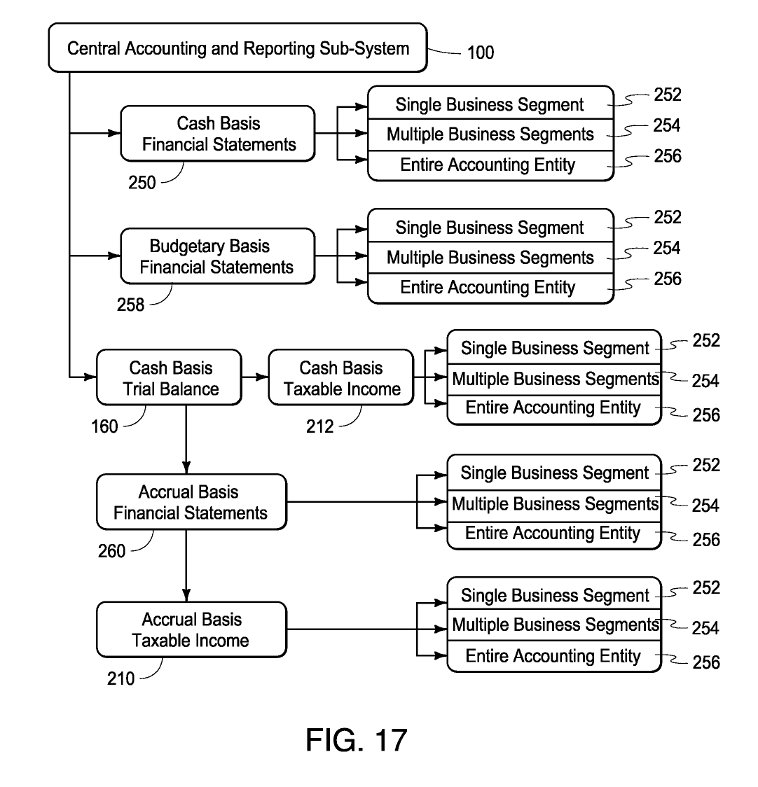

This wide range of financial statements and reports, including accrual basis financial statements, is available not just at the accounting entity level, but at the business segment (sub-entity) level as well, in various embodiments. This is illustrated in FIG. 17.

In the embodiments shown in FIG. 17, the central accounting and reporting sub-system 100 selectively generates cash basis financial statements 250 for a single business segment 252, multiple business segments 254, or an entire accounting entity 256. Also shown in FIG. 17, the central accounting and reporting sub-system 100 selectively generates budgetary basis financial statements 258 for a single business segment 252, multiple business segments 254, or an entire accounting entity 256. Also shown in FIG. 17, using the cash basis trial balance 160, the tax basis sub-system 106 (see FIG. 16) selectively generates cash basis taxable income statements 212 for a single business segment 252, multiple business segments 254, or an entire accounting entity 256. Also shown in FIG. 17, using the cash basis trial balance 160, the accrual basis sub-system 105 (see FIG. 16) selectively generates accrual basis financial statements 260 for a single business segment 252, multiple business segments 254, or an entire accounting entity 256. Also shown in FIG. 17, using the accrual basis income statement 214 (see FIG. 16), the tax basis sub-system 106 (see FIG. 16) selectively generates accrual basis taxable income statements 210 for a single business segment 252, multiple business segments 254, or an entire accounting entity 256.

A chart of accounts (COA) is a list of accounts used by an accounting entity to define each class of items for which money is spent or received by the entity. The listing is usually hierarchical in nature and the accounts are usually placed into groups. Accounts typically are identified by an account number and an account description.

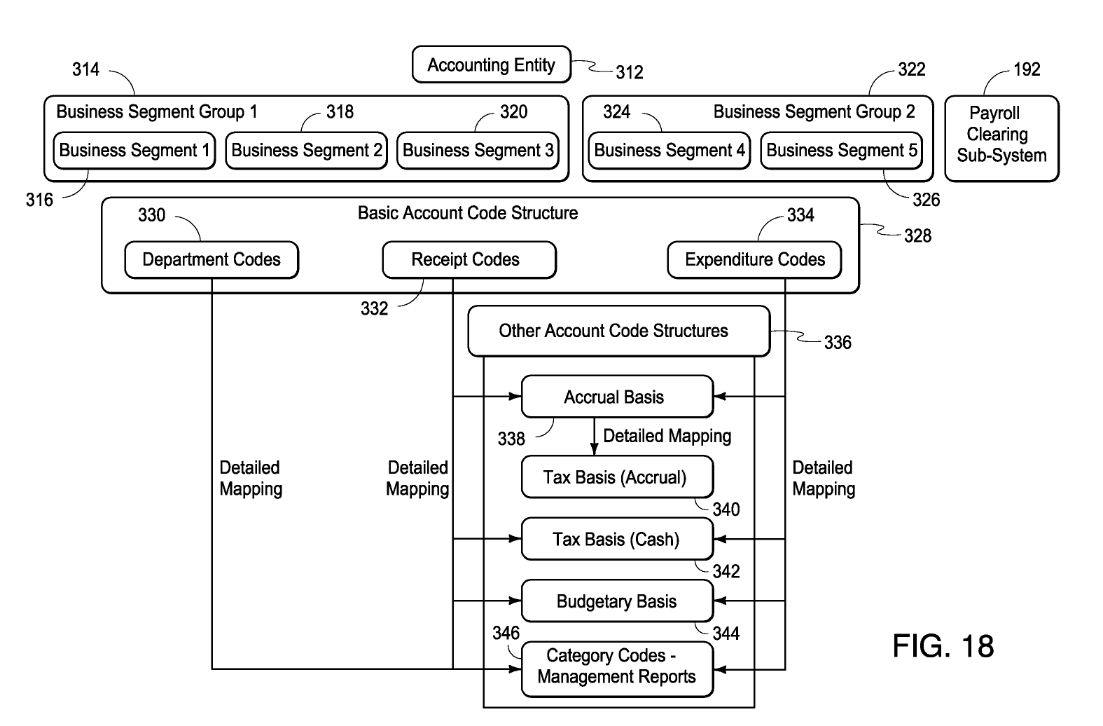

As shown in FIG. 18, at the top of the hierarchy is the accounting entity 312. Next are the business segment groups 314 and 322 and the business segments 316, 318, 320, 324, and 326. Next are various different account code structures designed for different types of reporting (e.g., 328).

In various embodiments, the Payroll Clearing Sub-System 192 occupies a somewhat unique position in the chart of accounts. Although it is considered to be an accounting sub-system, it is shown in the chart of accounts as basically the equivalent of a business segment. It is not a business segment, of course, but it is treated much like a business segment for accounting purposes. The Payroll Clearing Sub-System 192 receives cash from inter-segment transfers, and disburses cash for substantially all payroll-related transactions. It is designed to act as a payroll transactional clearinghouse. The Payroll Clearing Sub-System 192 has been described previously (see FIG. 12).

The system 30 (see FIG. 2) of various embodiments provides a default chart of accounts that is tailored to the accounting entity. But it can be altered to accommodate the needs and preferences of the business owner.

As shown in FIG. 18, the chart of accounts employs an integrated group of several different account code structures. There is a separate account code structure (i.e., set of account codes) for each type of financial statements and reports.

The chart of accounts of the system 30 includes the following account code structures (see FIG. 18): 1) basic account code structure 328, 2) accrual basis account code structure 338, 3) accrual tax basis account code structure 340, 4) cash tax basis account code structure 342, 5) budgetary basis account code structure 344, and 6) category account code structure 346.

The basic account code structure 328 is used for cash basis and budgetary basis reporting in central sub-system 100. The basic account code structure 328 contains the lowest level of account detail and supports the wide range of reporting in central sub-system 100, which ranges from financial statements summarized at the business segment and accounting entity levels, to “drill-down” detailed reporting that ties to specific items reported in summarized financial statements.

The account codes included in the other account code structures 336 (see FIG. 18) are used for higher level reporting (see FIG. 3), such as accrual basis 105 financial statements, tax basis 106 financial statements, budgetary basis 107 financial statements, and reporting by category.

The system 30 of various embodiments provides a chart of accounts designed to map original journal entries, stored in central sub-system 100 using detailed account codes in the basic account code structure 328, to the appropriate account codes in one or more of the other account code structures 336. The mapping process is manifested in cash basis trial balances created from detailed cash transactions stored in central sub-system 100 and summarized in a trial balance format using the account code structure of the reporting sub-system (e.g., accrual basis sub-system 105).

In various embodiments, when a Cash Receipt is recorded, the following information at a minimum is stored in the system 30:

### Date

### Business Segment

Department (optional)

### Receipt Type

In various embodiments, when a Cash Disbursement/Expenditure is recorded, the following information at a minimum is stored in the system:

### Date

### Business Segment

### Department

### Disbursement/Expenditure Type

These detailed transactions are stored in the central sub-system 100, and eventually make their way to various financial statements and reports in the accounting system 30 using a detailed mapping system set up in the chart of accounts (see FIG. 18).

Within the chart of accounts (see FIG. 18) respective cash basis receipt accounts are mapped to specific revenue accounts that are part of the accrual basis set of accounts. Similarly, respective cash basis disbursement/expenditure accounts are mapped to specific expense accounts that are part of the accrual basis set of accounts. This mapping system provides the basis for creating a cash basis trial balance 160 that serves as the starting point for the accrual basis financial statements 200 (see FIG. 13). Similarly cash basis trial balances are created for other types of financial reporting using detailed mapping to other account code structures 342, 344, and 346.

As shown in FIG. 18, at the top hierarchical level of the chart of accounts, there is only a single business entity 312. This might be a holding company or a business enterprise that owns and operates other businesses.

The next (second) level comprises business segment groups 314, 322 (e.g., groups of sub-entities). In the chart of accounts of various embodiments of the system 30, there is no limit to the number of business segment groups that can be included. Each group 314, 322 is assigned a code number and a code name. A group of business segments might include segments of a particular commercial type or industrial type.

The next (third) level comprises business segments 316, 318, 320, 324, and 326 (e.g., sub-entities). In the chart of accounts of various embodiments, there is no limit to the number of business segments that can be included. Each business segment 316, 318, 320, 324, and 326 is assigned a code number and a code name. Business segments 316, 318, 320, 324, and 326 can be tagged as belonging to a specific group. This tagging facilitates the consolidation of multiple business segments for financial reporting purposes. A business segment 316, 318, 320, 324, and 326 may or may not be assigned to a group depending on the needs of the business owner.

The next (fourth) level 328 includes department codes 330 (e.g., for service departments). In the chart of accounts of various embodiments, there is no limit to the number of department codes that can be included. Each department 330 is assigned a code number and a code name. Departments are tagged in the chart of accounts for use by specific business segments. A department might be used by a single business segment or multiple business segments. The purpose of this tagging is to prevent unauthorized use of department codes by a business segment, and thereby avoid transactional coding errors.

The next (fifth) level includes two sets of detailed codes. The first set of codes for the fifth level comprises receipt codes 332 (e.g., for charges for services). In the chart of accounts of various embodiments, there is no limit to the number of receipt codes that can be included. Each receipt code is assigned a code number and a code name. Receipt codes are tagged in the chart of accounts for use by specific business segments. A receipt code might be used by a single business segment or multiple business segments. The purpose of this tagging is to prevent unauthorized use of receipt codes by a business segment, and thereby avoid transactional coding errors. Receipt codes are intended to record cash receipts in as much detail as the business owner needs. Detailed reporting at the receipt code level is useful primarily for management purposes. For higher level reporting, these detailed receipt codes are mapped to different sets of higher level codes used for special reporting purposes, such as accrual basis financial reporting (GAAP statements), tax basis financial reporting, and budgetary basis financial reporting.

The second set of codes for the fifth level comprises expenditure, expense, or disbursement codes 334. In the chart of accounts of various embodiments, there is no limit to the number of expenditure codes that can be included. Each expenditure code is assigned a code number and a code name. Expenditure codes are tagged in the chart of accounts for use by specific business segments. An expenditure code might be used by a single business segment or multiple business segments. The purpose of this tagging is to prevent unauthorized use of expenditure codes by a business segment, and thereby avoid transactional coding errors. Expenditure codes are intended to record expenditure related transactions in as much detail as the business owner needs. Detailed reporting at the expenditure code level is useful primarily for management purposes. For higher level reporting, these detailed expenditure codes are mapped to different sets of higher level codes used for special reporting purposes, such as accrual basis financial reporting (GAAP statements), tax basis financial reporting, and budgetary basis financial reporting.

In addition to a basic chart of accounts designed to record and report detailed financial transactions, the chart of accounts (see FIG. 18) incorporates various other account code structures designed for higher level reporting purposes. These other types of financial statements and reports include, for example, 1) accrual basis financial statements (GAAP statements) 338, 2) tax basis financial statements 340 and 342, 3) budgetary basis financial statements 344, and 4) reporting by category 346.

In various embodiments, the account code structure used for accrual basis (GAAP) financial statements is generally the equivalent of the general ledger accounts used for the balance sheet and the income statement (profit and loss statement). An example structure for accrual basis financial statements is as follows:

### Overview Balance Sheet Accounts:

Asset Accounts
Cash
Investments
Accounts Receivable
Prepaid Expenses
Inventory
Vehicles and Equipment (less accumulated depreciation)
Buildings (less accumulated depreciation)
Other Assets

Liability Accounts
Accounts Payable
Tax Payable
Payroll Payable
Long-Term Debt

Stockholders' Equity Accounts
Common Stock
Retained Earnings

### Overview Income Statement Accounts:

Revenue Accounts
Sales Revenue (less returns and allowances)
Investment Income

Expense Accounts
Payroll
Advertising and Marketing
Professional Fees
Information Technology
Depreciation
Rent
Utilities
Insurance
Travel
Taxes

Revenue and expense codes for tax basis financial statements using the accrual basis of accounting, in various embodiments, parallels those used for GAAP financial reporting, but they are not necessarily identical.

An example structure for tax basis financial statements using the cash basis of accounting is as follows, for schedule C reporting as an example:

Receipt Accounts
Sales
Other Income

Expenditure Accounts
Advertising
Car and Truck Expenses
Contractual Labor
Depreciation Expense
Employee Benefit Programs
Insurance
Interest
Professional Services
Office Expenses
Rent
Repairs and Maintenance
Supplies
Taxes and Licenses
Travel
Utilities
Wages
Other Expenses

An example structure for budgetary basis financial statements is as follows:

### Receipt/Revenue Accounts

Sales

Investment Income

Other Income

### Expenditure/Expense Accounts

Payroll

Contractual Services

Materials and Supplies

Capital Outlay

In various embodiments, the above account codes have a code number and a code name.

The account codes used in the various account code structures used for other financial reporting will vary depending on the type of entity (business, local government, or individual), the type of business segment, and the needs of the accounting entity. Some of the account code structures will not even be used by certain accounting entities.

The chart of accounts (see FIG. 18) employs mapping that facilitates the creation of a cash basis trial balance from detailed transactions stored in the central sub-system 100 and used by another sub-system for financial reporting purposes. A common example of this is the creation of a cash basis trial balance for the accrual basis sub-system 105.

For example, Receipt Codes in the basic account code structure that are used to record detailed receipts are mapped to corresponding Revenue Codes in the accrual basis account code structure in various embodiments.

Expenditure Codes in the basic account code structure that are used to record detailed cash disbursement transactions are mapped to corresponding Expense Codes in the accrual basis account code structure in various embodiments.

Using the mapping in the chart of accounts, a cash basis trial balance is created from the cash transactions stored in the central sub-system 100. The trial balance, however, shows the dollar amounts using the Revenue Accounts and Expense Accounts for the accrual basis financial reporting sub-system. The mapping system translates the cash transactions from the detailed account codes to the higher level account codes used in the accrual basis sub-system.

Revenue Codes and Expense Codes in the GAAP accrual basis sub-system are mapped to corresponding Revenue Codes and Expense Codes in the Tax Basis (accrual) account code structure, in various embodiments.

Mapping performs a translation function to convert cash transactions from one account code structure (detailed accounts) to another, higher level, account code structure. A common application of mapping is to translate detailed cash receipts and cash disbursements stored in the central sub-system 100 to the higher level revenue and expense codes used in the accrual basis sub-system 105. A difficulty that arises when making the translation is that not all cash receipts are revenues, and not all cash disbursements are expenses under the accrual basis of accounting. Hence, the tagging feature of the system 30 (see FIGS. 14 and 15) identifies those transactions to alert the financial statement preparer to the possible need for adjusting entries to reverse the translated entry, and handle the transaction differently in the accrual basis sub-system.

The chart of accounts of the system 30 has another account code structure referred to as Category Codes 346. Category codes are not designed to prepare financial statements. Instead, their purpose is to provide high level reports that summarize cash receipts by category, expenditures by category, and department level receipts and expenditures by category. Category codes are usually set up based on the needs and preferences of the business owner and vary from entity to entity.

In the chart of accounts there is no limit on the number of possible category codes. Each category code is assigned a code number and a code name. In the illustrated embodiment, there are three types of category codes—1) receipt category codes, 2) expenditure category codes, and 3) department category codes.

In various embodiments, category codes work as follows. Receipt Codes in the basic account code structure that are used to record detailed receipts are mapped to the appropriate Receipt Category Codes. Expenditure Codes in the basic account code structure that are used to record detailed cash disbursement transactions are mapped to corresponding Expenditure Category Codes in various embodiments. Department Codes in the basic account code structure that are used to record detailed cash transactions are mapped to corresponding Department Category Codes in various embodiments.

Using the mapping system in the chart of accounts, a category level financial report is selectively created from the cash transactions stored in the central sub-system. The category report shows a high level report of cash receipts summarized by Receipt Categories or cash disbursements summarized by Expenditure Categories. Another category report shows a summary of cash receipts and cash disbursements by Department Categories. Category reports can be created for a single business segment, a business segment Group, or entity-wide.

As described above, there are typically transactions in the cash basis trial balance that are not actually accrual basis revenues and expenses. However, the system 30 uses tagging to identify such transactions as possibly requiring an adjusting entry under accrual basis reporting requirements.

Various embodiments of the system 30 provide transaction tagging where financial transactions stored in the data warehouse are similar in most respects, but are tagged in some way to be able to identify or distinguish them from the other similar transactions for a special purpose.

Assume the data warehouse 26 contains transactions of payments made by the business owner to vendors. That transaction typically would contain the following pieces of information: 1) date of payment, 2) the vendor receiving the payment, 3) the purpose of the payment (identified with a code from the chart of accounts), and 4) the amount of the payment.

If the payment was for something that is purchased for common daily business expenses, such as gasoline for a vehicle that will be consumed in a few days, likely the payment transaction would not be tagged for any special purpose. This would be the case for most of the business's expenditures.

On the other hand, assume the business owner purchases a $75,000 piece of equipment. This payment would be tagged as the purchase of an asset that cannot be expensed entirely for the year it was purchased. And therefore, the transaction would be tagged accordingly to ensure it is not overlooked.

The system 30 of various embodiments allows the business owner to identify (and tag) transactions that meet certain requirements. The identification requirements can be pre-set in the chart of accounts. They can be set in the chart of accounts after the transactions have already taken place, or the business owner can do an inquiry “on the fly.” In various embodiments, most of these tagging requirements would be set up in the chart of accounts of the system 30 by default. However, the business owner has complete flexibility to add to, delete, or change what is in the chart of accounts by default.

In our example, assume there is tagging identification requirement in the chart of accounts that does the following: for the purchase of any item that is given an “equipment” code and exceeds $5,000, the transaction will be tagged as needing an adjustment for capitalization purposes (i.e., depreciation).

To keep it simple, if the business owner prepares accrual basis financial statements at year-end, the system 30 of various embodiments creates a cash basis trial balance specifically designed to be used for that purpose. In the trial balance would be a cash disbursement for $75,000 that would be tagged, thereby alerting the business owner (or the accountant) that an adjustment is needed to reverse the $75,000 disbursement so it would not appear in the financial statements as an expense. It also alerts the business owner that another adjusting entry is needed to capitalize the $75,000 purchase (i.e., record an asset and start depreciating it). This is illustrated in FIG. 14.

The tagging process of various embodiments is a little more complicated because the purchase might constitute a lease-purchase in which case another tag would be triggered for long-term debt. Also, there might be several smaller payments related to the purchase, in which case all of the payments would need to be combined for possible adjustment purposes. The tagging process is designed to handle these types of situations. Also, note that the tagging process is not designed specifically for the business owner. The business owner would have an accountant on the staff (or even hire a consultant to come in at year-end to prepare the accrual basis financial statements).

Although tagging is probably most useful for accrual basis financial reporting, it is not limited to that. The tagging technique can apply to whatever the business owner's needs are. For example, tagging could be used for tax basis reporting. Also, some individual transactions will be tagged for multiple external reporting purposes (e.g., accrual basis and tax basis reporting).

The central accounting sub-system 100 provides the cash basis trial balance that serves as the starting point for external reporting sub-systems. By tagging transactions included in the trial balance that possibly need adjusting entries, the trial balance becomes significantly more manageable.

An advantage of the system 30, with its chart of accounts mapping, transactional tagging, and the wide range of reporting capabilities of the central sub-system 100, the banking sub-system 102, the billing and accounts receivable sub-system 103, and the payroll sub-system 104, is to provide the business owner with various options not only on what financial statements to prepare, but also when to prepare them. For example, one business owner might decide to rely primarily on sub-systems 100, 102, 103, and 104 for both interim (monthly) and year-end financial reporting, and not prepare accrual basis financial statements. A second business owner might decide to do the same, except to also prepare accrual basis financial statements at year-end. A third business owner might decide to do the same as the second business owner, but also prepare quarterly accrual basis financial statements. The business owner has this type of flexibility under the system 30.

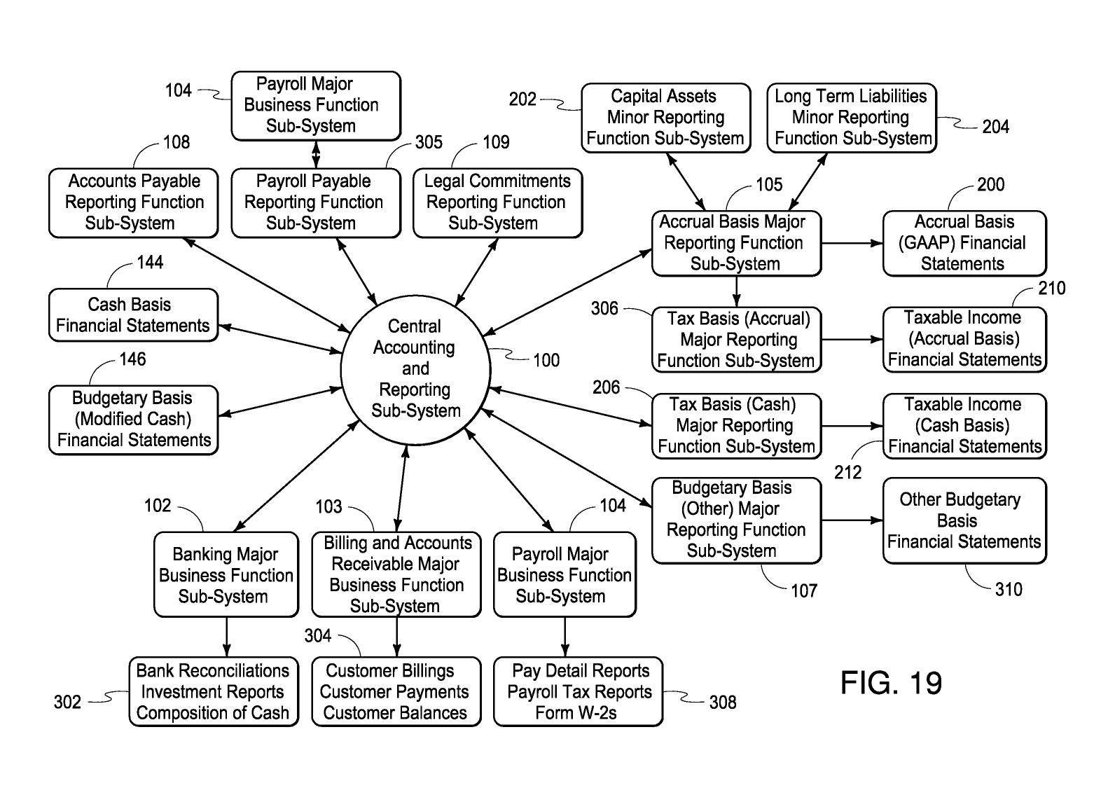

FIG. 19 is a functional block diagram similar to FIG. 3 but showing more detail, in accordance with various embodiments. In the embodiments illustrated in FIG. 19, data conversion occurs between the banking sub-system 102 and the central accounting and reporting sub-system 100; between the billing and accounts receivable sub-system 103 and the central accounting and reporting sub-system 100; between the payroll sub-system 104 and the central accounting and reporting sub-system 100; between the accounts payable sub-system 108 and the central accounting and reporting sub-system 100; between the payroll payable sub-system 305 and the central accounting and reporting sub-system 100; and between the legal commitments sub-system 109 and the central accounting and reporting sub-system 100. These sub-systems 102, 103, 104, 108, 305 and 109 have been previously described. In some embodiments, the payroll payable reporting function sub-system 305 is included in or in communication with the payroll sub-system 104.

FIG. 19 also shows financial reporting from the banking sub-system 102 to generate bank reconciliations, investment reports, and composition of cash reports, all generally indicated as 302. FIG. 19 also shows financial reporting from the billing and accounts receivable sub-system 103 to generate customer billings reports, customer payments reports, and customer balances reports, all generally indicated as 304. FIG. 19 also shows financial reporting from the payroll sub-system 104 to generate pay detail reports, payroll tax reports, and tax documents such as W-2 forms, all generally indicated as 308 and previously referred to as 182, 184, and 186 (see FIG. 12).

FIG. 19 also shows financial reporting from the central accounting and reporting sub-system 100 to generate cash basis financial statements 144 and budgetary basis financial statements 146. Statements 144 and 146 have been previously described.

FIG. 19 also shows using a trial balance from the central accounting and reporting sub-system 100 in the accrual basis sub-system 105, in the tax basis (cash) sub-system 206, and the budgetary basis sub-system 107. The tax basis (accrual) sub-system 306 is shown as using a trial balance from the accrual basis sub-system 105. FIG. 19 also shows data conversion between the capital assets sub-system 202 and the accrual basis sub-system 105. FIG. 19 also shows data conversion between the long-term liabilities sub-system 204 and the accrual basis sub-system 105. These sub-systems 105, 306, 206, 107, 202, and 204 have been previously described.

FIG. 19 also shows financial reporting from the accrual basis sub-system 105 to generate accrual basis (GAAP) financial statements 200; financial reporting from the tax basis (accrual) sub-system 306 to generate taxable income (accrual basis) financial statements 210; financial reporting from the tax basis (cash) sub-system 206 to generate taxable income (cash basis) financial statements 212; and financial reporting from the budgetary basis sub-system 107 to generate other budgetary basis financial statements 310.

While some embodiments disclosed herein are implemented in software, alternative embodiments comprise hardware, such as hardware including digital logic circuitry. Still other embodiments are implemented in a combination of software and digital logic circuitry.

While certain functions are illustrated as being performed in certain blocks, it should be understood that various functions may be performed in other blocks or in a combination of blocks. The blocks do not necessarily correspond to software functions or routines, to integrated circuits or to circuit blocks. Multiple blocks may be defined by a single function, routine or integrated circuit or a single block may be defined by multiple functions, routines or integrated circuits.

Various embodiments provide a computer-usable or computer-readable medium, such as a hard drive, solid state memory, flash drive, floppy disk, CD (read-only or rewritable), DVD (read-only or rewritable), tape, optical disk, floptical disk, RAM, ROM (or any other non-transitory medium capable of storing program code) bearing computer program code which, when executed by a computer or processor, or distributed processing system, performs various of the functions described above.

Some embodiments provide a carrier wave or propagation signal embodying such computer program code for transfer of such code over a network or from one device to another. The term “non-transitory,” if used in the claims, is meant to exclude only such a carrier wave or propagation signal.

In compliance with the patent laws, the subject matter disclosed herein has been described in language more or less specific as to structural and methodical features. However, the scope of protection sought is to be limited only by the following claims, given their broadest possible interpretations. The claims are not to be limited by the specific features shown and described, as the description above only discloses example embodiments.

I/we claim:

1. An accounting system configured to record single entry transactions including transactions for cash receipts, cash disbursements, accounts payable, payroll payable, and legal commitments and to generate, in response to a selection by a user made after the transactions have been recorded, a selected one of a cash basis statement, and a budgetary basis statement.

2. An accounting system in accordance with claim 1 wherein the transactions include transactions for a business entity and for a subsidiary of the business entity, and configured, in response to a selection by a user, to generate statements for a selected one of the business entity and the subsidiary of the business entity, after the transactions have been recorded.

3. An accounting system in accordance with claim 1 wherein the transactions include cash basis transactions and configured to generate a cash basis trial balance from the cash basis transactions, to receive adjusting entries from a user, and to generate accrual basis statements using the cash basis trial balance and the adjusting entries and to generate tax basis statements using a cash basis trial balance and adjusting entries, and to generate budgetary basis statements using a cash basis trial balance and adjusting entries.

4. An accounting system in accordance with claim 3 and configured to generate a cash basis trial balance from transactions, to tag cash transactions that may require an adjusting entry for accrual basis financial statements, and, in response to a request, to generate a report identifying tagged transactions that may require an adjusting entry for accrual basis statements, and to tag cash transactions that may require an adjusting entry for tax basis financial statements, and in response to a request, to generate a report identifying tagged transactions that may require an adjusting entry for tax basis statements, and to tag cash transactions that may require an adjusting entry for budgetary basis financial statements, and, in response to a request, to generate a report identifying tagged transactions that may require an adjusting entry for budgetary basis financial statements.

5. An accounting system in accordance with claim 1 and configured to track legal commitments including purchase orders, employee contracts, vendor contracts, long-term service contracts of more than one year, long-term rental agreements of more than one year, and lease agreements.

6. An accounting system in accordance with claim 5 and configured to monitor uncommitted cash using a budgetary basis of accounting.

7. An accounting system in accordance with claim 1 and having a central sub-system, a banking sub-system in communication with the central sub-system and configured to receive data from bank statements, and wherein the central sub-system is configured to receive bank statement data from the banking sub-system.

8. An accounting system in accordance with claim 7 and further comprising a billing and accounts receivable sub-system, in communication with the central sub-system, configured to receive payment data and wherein the central sub-system is configured to receive payment data from the billing and accounts receivable sub-system.

9. An accounting system in accordance with claim 7 and further comprising a payroll sub-system, in communication with the central sub-system, configured to receive payroll cost data and wherein the central sub-system is configured to receive payroll cost data from the payroll sub-system.

10. An accounting system in accordance with claim 9 wherein the payroll sub-system is configured to generate payroll reporting data.

11. An accounting system in accordance with claim 9 wherein the payroll sub-system includes a payroll clearing sub-system configured to process disbursements related to payroll.

12. An accounting method comprising:
recording transactions;
generating a cash basis trial balance from the transactions;
tagging cash transactions that may require an adjusting entry for accrual basis financial statements;
tagging cash transactions that may require an adjusting entry for tax basis financial statements;
tagging cash transactions that may require an adjusting entry for budgetary basis financial statements;
tracking legal commitments including at least three of purchase orders, employee contracts, vendor contracts, long-term service contracts, long-term rental agreements, and lease agreements;
in response to a request, generating a report identifying tagged transactions that may require an adjusting entry for accrual basis financial statements;
in response to a request, generating a report identifying tagged transactions that may require an adjusting entry for tax basis financial statements;
in response to a request, generating a report identifying tagged transactions that may require an adjusting entry for budgetary basis financial statements;
importing a cash basis trial balance;
receiving, from a user, adjusting entries for accrual basis financial statements;
receiving, from a user, adjusting entries for tax basis financial statements;
receiving, from a user, adjusting entries for budgetary basis financial statements;
in response to a selection by a user after the transactions have been recorded, generating any selected one of a cash basis, budgetary basis, accrual tax basis, cash tax basis, and accrual basis financial statements for any of a year and an interim period of less than a year.

13. A method in accordance with claim 12 wherein the transactions include single entry transactions for a business entity and for a subsidiary of the business entity, the method further comprising receiving a selection by a user and generating one of cash basis and budgetary basis statements for one of the business entity and the subsidiary of the business entity in response to the selection, after the single entry transactions have been recorded.

14. A method in accordance with claim 13 and further comprising generating a cash basis trial balance from the cash basis transactions, and generating accrual basis statements, tax basis statements, and budgetary basis statements based, at least in part, on the cash basis trial balance.

15. A non-transient computer readable medium bearing computer program code which, when executed by a computer causes the computer to perform the method of claim 12.

16. An accounting system comprising:
a central sub-system;
a banking sub-system in communication with the central sub-system and configured to receive data from bank statements, the central sub-system being configured to receive bank statement data from the banking sub-system;
a billing and accounts receivable sub-system, in communication with the central sub-system, and configured to receive data about incoming payments, and the central sub-system being configured to receive payment data from the billing and accounts receivable sub-system; and
a payroll sub-system, in communication with the central sub-system, and configured to receive payroll cost data, the central sub-system being configured to receive payroll cost data from the payroll sub-system, the payroll sub-system being configured to generate payroll reporting data and to process payroll payable;
the central sub-system being configured to track legal commitments including purchase orders, employee contracts, vendor contracts, long-term service contracts of more than one year, long-term rental agreements of more than one year, and lease agreements; and being configured to generate, in response to a selection by a user made after the payroll payable transactions have been processed, a selected one of a cash basis report, and a budgetary basis report.

17. An accounting system in accordance with claim 16 wherein the central sub-system is configured to receive data for single entry transactions for a business entity and for a subsidiary of the business entity, the single entry transactions including transactions for cash receipts, cash disbursements, accounts payable, payroll payable, and legal commitments, and to store the data for the transactions in the data warehouse, wherein the system is configured, in response to a selection by a user, to switch between generating cash basis and budgetary basis statements for a selected one of a business entity and the subsidiary of the business entity, and wherein the system is configured to generate a cash basis trial balance from the data for the single entry transactions, to receive adjusting entries from a user, and to generate accrual basis statements, tax basis statements, and budgetary basis statements using the cash basis trial balance and the adjusting entries.

18. An accounting system in accordance with claim 16 and including a chart of accounts including account codes and account descriptions to define classes of items for which money is spent and for which money is received, the chart of accounts having a hierarchy including at least an accounting entity level, business segment group level, and business segment level.

19. An accounting system in accordance with claim 18 wherein the chart of accounts has different sets of account codes for different types of financial statements, the sets including at least a basic account code set for cash basis and budgetary basis reporting, an accrual basis account code set, an accrual tax basis account code set, a cash tax basis account code set, a budgetary basis account code set, and a category account code set.

20. An accounting system in accordance with claim 19 wherein the chart of accounts provides account code mapping between the basic account code set, which provides a first level of detail, and an account code set which provides a second level of detail higher than the first level, the account code set having the second level of detail being selected from the group consisting of the accrual basis account code set, the accrual tax basis account code set, the cash tax basis account code set, the budgetary basis account code set, and the category account code set.
